(19) United States
(12) Patent Application Publication
(10) Pub. No.: US 2003/0060198 A1
(43) Pub. Date: Mar. 27, 2003

(54) Method for controlling communication function of mobile phone and mobile phone thereof

(75) Inventor: Changzhu Li, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Huawei Technologies Co., Ltd.

(21) Appl. No.: 10/253,239

(22) Filed: Sep. 23, 2002

(30) Foreign Application Priority Data
Sep. 25, 2001 (CN) 01135381.3

(51) Int. Cl. H04M 3/00; H04Q 7/20

(52) U.S. Cl. 455/434; 455/418; 455/419

(57) ABSTRACT

The invention discloses a method for controlling the selection of a communication function or a non-communication function of a mobile phone, and provides a mobile phone with the controlled communication function. This includes: setting a communication function selection item, adding a communication function control part; and under the control of the mobile phone control part, a subscriber can select the mobile phone communication function is whether at activated state or at closed state. When the communication function of a mobile phone is at an activated state, the mobile phone is connected with a network. When the communication function of a mobile phone is at a closed state, the mobile phone is not connected with a network. Therefore, the invention gives convenience to a mobile phone subscriber to activate the communication function to connect with a network or to close the communication function without connecting to a network. In this way, a subscriber can better select and use various communication functions and non-communication functions of a mobile phone.

### FIELD OF THE INVENTION

The present invention relates generally to mobile phone technology, and more particularly to a control method of the communication function of a mobile phone and a mobile phone with the communication function controlled. The invention can be used in a mobile phone of the second generation (2G) or the second-generation enhanced (2.5G) mobile communication system. The invention also is especially suitable for a mobile phone combining with PDA (Personal Digital Assistance) technology in the future.

### BACKGROUND OF THE INVENTION

A present mobile phone (including those used in TACS/GSM/GPSR) is a micro radio transceiver. Startup or implementing of a mobile phone's functions is controlled by a CPU in the phone. The CPU executes a preset program.

After a mobile phone is switched on, batteries of the phone supply power to the CPU. The CPU executes instructions in the program: first calls the power on program to execute the phone initialization procedure, then initializes modules such as the radio frequency module, etc. After that, the mobile phone starts to receive a downlink signal from a network using the antenna. Under CPU controls, the mobile phone searches a cell, reads broadcasting channel information and synchronizes with the system etc. until a cell registration is successful. At this time, the mobile phone is ready for acknowledgement of a call or initiating a call.

These procedures are automatically completed by a mobile phone without any subscriber interference. During the operation period, the network can call the subscriber or the subscriber can launch a call to the network at any time. When a mobile phone is idle, (i.e. the phone does not have any incoming call or outgoing call with the network), the phone also must read common channels information, such as broadcasting channel, and make related measurement of the network.

The automatic searching and registration procedure of a mobile phone, mentioned above, is convenient and quick. However, it also means when a mobile phone is switched on, no matter whether it communicates with outside world, the phone is still connected with the network. Nevertheless, in the future a mobile phone combining with PDA technology includes many functions which are independent from the network communication, such as calculator, game, MP3 broadcasting, personal mailbox, editing of personal files, etc. Obviously, in this case communication with outside world is only part of functions of a mobile phone. If a mobile phone communication function is activated, once it is switched on and the mobile phone is in a waiting state; then it is not only consuming electric energy, but in some areas, such as an airplane where a mobile phone is inhibited, the functions without communication requirements cannot be used as well.

In overview, a present mobile phone searches a network and registers automatically after it is switched on, and keeps a status communication connecting with the outside network all along before it is switched off. Therefore, non-communication functions of a mobile phone cannot be used in some situations or places.

### SUMMARY OF THE INVENTION

In order to solve the problems mentioned above, the invention provides a method to control and select functions with or without communication of a mobile phone, also provides a mobile phone with the capability of control and selection communication functions. Therefore, the functions of a mobile phone are selectable to a subscriber.

The invention provides a method to control the communication function of a mobile phone, comprising:

Set a communication function selection item for a mobile phone.

Provide the communication function of a mobile phone is at an activated state or a closed state, which are selectable. When the communication function of a mobile phone is at an activated state, the mobile phone is connected with a network. When the communication function of a mobile phone is at a closed state, the mobile phone is not connected with a network. Consequently, no matter what state of the communication function a mobile phone is in, it can be switched between the two states randomly.

Inputting a selection instruction to a mobile phone can be implemented either by setting a button on the mobile phone, or by setting an item in the functions selection menu of the mobile phone. By initializing the selection program of the communication function state, the communication function may transfer from the current activated state to closed state or vice visa.

According to the method of the invention, a selection, mentioned above, can be stored in a mobile phone, so when the mobile phone is switched on, it is automatically at the state (communication function activated or communication function closed) which the selection points to.

According to the method of the invention, an initialized selection can be set for a mobile phone. With this initialized selection, the mobile phone will automatically execute an initialization procedure required by the initialized selection, when it is switched on. Therefore, the mobile phone will activate or close the communication function automatically when it is switched on.

According to the method of the invention, when a mobile phone is switched on for the first time, a function selection program is initiated and the communication functions selection is activated. The mobile phone will prompt the subscriber to input a selected function value and store it. After that, each time when the mobile phone is switched on, it will automatically activate or close the communication function according to the stored selected function value. Furthermore, the mobile phone can have a default value for the communication function state selection, so after a selection prompt if there is too long before a response, the mobile phone will take the default value as the selected value.

The invention also provides a mobile phone with a controlled communication function. The mobile phone includes an operation part, a control part, a wireless part, a duplex filter and an antenna. The mobile phone is characterized that it further includes a communication function selection part that is controlled by the control part and provides a selection for the communication function to be activated or closed.

The selection part of the communication function can be a button set on the mobile phone or an item set in the selection menu.

The mobile phone of the invention also includes a communication function display part, which shows whether the communication function is activated or closed.

The display part of the communication function, for example, can be an indicator light on the mobile phone or a display item on the mobile phone screen.

Although, the present mobile phone can provide some basic non-communication service, such as calculator, notebook etc.; but along with the combination of a mobile phone and the PDA technology, functions of a mobile phone will be increased greatly over the scope of conversation and internet service and even become a complete personal digital assistance. Therefore, comparing with the present mobile phone, the invention will provide that a subscriber can select activating or closing the communication function according to a specific situation or site when a mobile phone is switched on, and select activating or closing the communication function at any time after a mobile phone is switched on. In this way, saving power of a mobile phone and giving convenience to a subscriber can be obtained.

### BRIEF DESCRIPTION OF THE DRAWINGS

FIG. 1 is a function block diagram of a mobile phone of an embodiment of the invention.

### DETAILED DESCRIPTION OF PREFERRED EMBODIMENTS

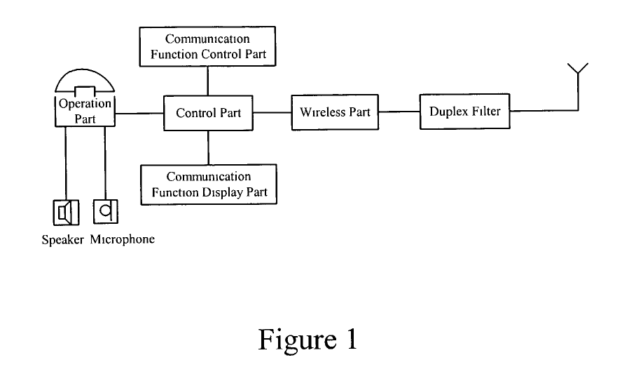

Referring to FIG. 1, from the functional point of view, a present mobile phone includes an operation part, such as keyboard, a control part, (i.e., CPU), a wireless part, a duplex filter and an antenna. The invention is based on the present mobile phone and added with a selection item of the communication function and a communication function control part. Under the control of the communication function control part, a subscriber can select whether the communication function is activated (enable) or closed (disable). When the communication function is activated, the mobile phone is connected with a network. When the communication function is closed, the mobile phone is disconnected with a network.

The communication function control part can be a button set on the mobile phone, or a menu selection item.

The invention further includes a communication function display part, which shows whether the communication function is in an activated state or a closed state. When the communication function state is changed, the display part is changed accordingly to show to a subscriber the present communication function state.

The communication function display part can be an indicator on the mobile phone or a display item on the mobile phone screen.

In the following, several embodiments of the invention are described. Of course, the invention is not limited by the introduced embodiments. The invention can be further revised or combined with the disclosed characteristics.

Embodiment 1

A selection item for whether the communication function is automatically activated, when switching on, is set in a mobile phone. If the selection is “yes” when switching on, the mobile phone searches a cell and registers automatically, then keeps a communication connection with the network. This is same as the present mobile phone. If the selection is “no” when switching on, there are no activities with the intent to connect with outside world, such as searching a cell, etc.

The mobile phone saves a subscriber's selection, which represents the latest selection of the subscriber.

Further, a default selection can be set in the CPU control program. The default selection can be the communication function or the non-communication function. When a mobile phone is switched on, if no selection is input, the mobile phone will take the default selection.

Preferably, this selection is implemented by a CPU control program. When switching on, the program instructs the CPU to read the stored selection parameter that controls the mobile phone initial execution. Therefore, when switching on, according to the program instructions, the CPU will decide whether to initiate a series of related modules to perform a cell searching and registration. Each time when a mobile phone is switched on, the CPU first reads the stored selection parameter (when there is no selection parameter, the default selection is instead). If the stored selection parameter shows “yes,” then the execution is same as the present mobile phone. This means that when switching on, searching a cell and registration is automatically taken, and connection with the network is kept. If the stored selection parameter shows “no,” then when switching on, the CPU will not execute activities of searching a cell and directly registering and the antenna is closed. At this time, a subscriber can use the non-communication functions of the mobile phone.

Embodiment 2

A button or an optional menu item is set in a mobile phone. During use of a mobile phone, for example, from a non-communication function and transferring to a communication function, a subscriber can activate the communication function through the button or a selection of the menu item. In this way, a subscriber can switch the mobile phone between two kinds of functions: communication and non-communication.

It is very convenient and helpful to a subscriber to select to close the communication function instead of switching off the mobile phone. For example, a passenger is going to board an airplane, through closing the communication function, it makes it possible for the passenger to use the non-communication functions, such as personal mailbox, file management, etc., in the airplane.

It is similar to embodiment 1, in that while using a mobile phone, changing the selection of functions will change the parameters which CPU control program points to. According to the subscriber's selection, the CPU will open or close related modules' functions, such as a radio frequency module; the antenna will start to transmit/receive or stop to transmit/receive, so the execution of the mobile phone is changed.

The CPU internal control program instructs the CPU to read the selection parameter in real time. According to the selection parameter, the CPU is triggered to execute corresponding functions in time. If a subscriber's selection is to transfer from a communication state to a non-communication state, (i.e., the communication function of the mobile phone is transferred from an activated state to a closed state), then the CPU closes a series of radio frequency modules, closes the antenna transmitting/receiving function and cuts off the connection between the mobile phone and the network. At this time, batteries supply power to the CPU continuously, but the CPU will only execute the non-communication functions. Similarly, if a subscriber selection is transferred from a non-communication state to a communication state, (i.e., the communication function of the mobile phone is transferred from a closed state to an activated state), then the CPU will initiate a series of radio frequency modules, open the antenna transmitting/receiving function, search a cell and register, and connect with a network.

Embodiment 3

A mobile phone indicates whether the current state of the communication function is at an activated state through a mode, which is convenient to a subscriber, such as a symbol on the screen or a flash lamp. When they appear, the communication function is at an activated state. When they disappear, the mobile phone is at a non-communication state; (i.e., the communication function is at a closed state).

In the present mobile phone, while switched on, in general, there is a mode indicating the connection state between the mobile phone and the network. This can be used as a base to indicate the communication function state for a mobile phone of the invention.

1. A method for controlling a communication function of a mobile phone having a communication function, which implements signal transmission between the mobile phone and a communication network, and non-communication functions, which do not depend on a communication network, comprising the steps of:
setting a communication function selection item; and
providing the ability to select whether the communication function is at an activated state or a closed state; when at an activated state, the mobile phone is communicating with the network; when at a closed state, the mobile phone is not communicating with the network.

2. The method according to claim 1, further comprising:
storing the selection value for the communication function selection item, as such selection value is selected by a subscriber; and
automatically executing the function selected by stored communication function selection value, when switching on the mobile phone.

3. The method according to claim 1, further comprising:
setting a power on initial selection value for the communication function selection item; and
automatically executing the function required by the power on initial selection value, when switching on the mobile phone.

4. The method according to claim 1, further comprising:
starting a function selection program to activate the communication function selection item, and prompting a subscriber to input selection instruction, when switching on the mobile phone for the first time;
storing the selection value for the communication function selection item, and
automatically executing the function selected by the stored communication function selection value, when switching on the mobile phone later.

5. The method according to claim 4, further comprising:
setting a default value for the communication function selection item;
taking the default value as the selected value, if the subscriber has no input selection instructions after a preset time.

6. The method according to claim 1, wherein the selecting is made by a communication function switching button set on the mobile phone; after a selection, the function selection program is executed and the communication function is switched from the current activated state to a closed state or from the current closed state to an activated state.

7. The method according to claim 1, wherein the selection is made by a communication function selection menu item in the mobile phone; after a selection, the function selection program is executed and the communication function is switched from the current activated state to closed state or from the current closed state to an activated state.

8. The method according to claim 1, further comprising:
setting a communication function indicator showing whether the mobile phone is at communication function state or at non-communication state; and
when the communication function is switched from one state to another, accordingly switching the indication.

9. A mobile phone with a controlled communication function comprises an operation part, a control part, a wireless part, a duplex filter and an antenna; wherein the mobile phone further comprises a communication function selection part which is controlled by the control part and provides a selection for the communication function to be activated or closed.

10. The mobile phone according to claim 9, wherein the communication function selection part is a switching button set on the mobile phone.

11. The mobile phone according to claim 9, wherein the communication function selection part is a communication function selection menu item in the mobile phone.

12. The mobile phone according to claim 9, further comprising a communication function display part for showing whether the communication function of the mobile phone is at an activated state or at a closed state.

13. The mobile phone according to claim 12, wherein the communication function display part is an indicator light set on the mobile phone.

14. The mobile phone according to claim 12, wherein the communication function display part is a display item on the mobile phone screen.
